(19) United States
(12) Patent Application Publication
(10) Pub. No.: US 2023/0366112 A1
(43) Pub. Date: Nov. 16, 2023

(54) METHOD OF PREPARING METAL OXIDE CATALYSTS FOR OXYGEN EVOLUTION

(71) Applicant: UOP LLC, Des Plaines, IL (US)

(72) Inventors: Zhanyong Li, Mount Prospect, IL (US); Chunqing Liu, Arlington Heights, IL (US); Dennis F. van der Vliet, Skokie, IL (US)

(21) Appl. No.: 17/662,677

(22) Filed: May 10, 2022

(51) Int. Cl. C25B 11/093; C25B 1/04; C25B 11/02; C25B 9/17

(52) U.S. Cl. CPC C25B 11/093; C25B 1/04; C25B 9/17; C25B 11/02

(57) ABSTRACT

Water electrolysis catalysts having reduced precious metal loading which are highly active and stable and methods of preparing the water electrolysis catalysts are described. The methods involve depositing a substantially continuous thin shell layer of a platinum group metal (PGM)-based precursor on a nano-sized inorganic oxide core to form a coated inorganic oxide core. The coated inorganic oxide core is heated in the presence of a template to convert the substantially continuous thin shell layer of the PGM-based precursor to a substantially continuous thin shell layer of PGM oxide. The template is then removed forming a water electrolysis catalyst comprising the nano-sized inorganic oxide core having a substantially continuous thin shell layer of the PGM oxide. The water electrolysis catalyst comprises less than 30 wt% of the PGM oxide.

Hydrogen as an energy vector for grid balancing or power-to-gas and power-to-liquid processes plays an important role in the path toward a low-carbon energy structure that is environmentally friendly. Water electrolysis produces high quality hydrogen by electrochemical splitting of water into hydrogen and oxygen; the reaction is given by Eq. 1 below. The water electrolysis process is an endothermic process and electricity is the energy source. Water electrolysis has zero carbon footprint when the process is operated by renewable power sources, such as wind, solar, or geothermal energy. The main water electrolysis technologies include alkaline electrolysis, proton exchange membrane (PEM) water electrolysis (PEM-WE as shown in FIG. 1), anion exchange membrane (AEM) water electrolysis (AEM-WE as shown in FIG. 2), and solid oxide water electrolysis.

As shown in FIG. 1, in a PEM-WE system 100, an anode 105 and a cathode 110 are separated by a solid PEM electrolyte 115 such as a sulfonated tetrafluoroethylene based cofluoropolymer sold under the trademark Nafion® by Chemours company. The anode and cathode catalysts typically comprise IrO₂ and Pt, respectively. At the positively charged anode 105, pure water 120 is oxidized to produce oxygen gas 125, electrons (e⁻), and protons; the reaction is given by Eq. 2. The protons are transported from the anode 105 to the cathode 110 through the PEM 115 that conducts protons. At the negatively charged cathode 110, a reduction reaction takes place with electrons from the cathode 110 being given to protons to form hydrogen gas 130; the reaction is given by Eq. 3. The PEM 115 not only conducts protons from the anode 105 to the cathode 110, but also separates the H₂ gas 130 and O₂ gas 125 produced in the water electrolysis reaction. PEM water electrolysis is one of the favorable methods for conversion of renewable energy to high purity hydrogen with the advantage of compact system design at high differential pressures, high current density, high efficiency, fast response, small footprint, lower temperature (20-90° C.) operation, and high purity oxygen byproduct. However, one of the major challenges for PEM water electrolysis is the high capital cost of the cell stack comprising expensive acid-tolerant stack hardware such as the Pt-coated Ti bipolar plates, expensive noble metal catalysts required for the electrodes, as well as the expensive PEM.

Water electrolysis reaction:

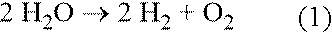

Oxidation reaction at anode for PEM-WE:

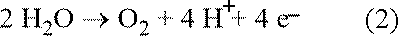

Reduction reaction at cathode for PEM-WE:

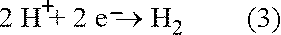

AEM-WE is a developing technology. As shown in FIG. 2, in the AEM-WE system 200, an anode 205 and a cathode 210 are separated by a solid AEM electrolyte 215. Typically, a water feed 220 with an added electrolyte such as dilute KOH or K₂CO₃ or a deionized water is fed to the cathode side. The anode and cathode catalysts typically comprise platinum metal-free Ni-based or Ni alloy catalysts. At the negatively charged cathode 210, water is reduced to form hydrogen 225 and hydroxyl ions by the addition of four electrons; the reaction is given by Eq. 4. The hydroxyl ions diffuse from the cathode 210 to the anode 205 through the AEM 215 which conducts hydroxyl ions. At the positively charged anode 205, the hydroxyl ions recombine as water and oxygen 230; the reaction is given by Eq. 5. The AEM 215 not only conducts hydroxyl ions from the cathode 210 to the anode 205, but also separates the H₂225 and O₂ 230 produced in the water electrolysis reaction. The AEM 215 allows the hydrogen 225 to be produced under high pressure up to about 35 bar with very high purity of at least 99.9%.

Reduction reaction at cathode for AEM-WE:

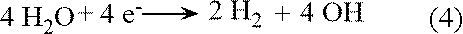

Oxidation reaction at anode for AEM-WE:

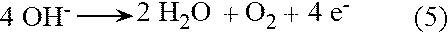

AEM-WE has an advantage over PEM-WE because it permits the use of less expensive platinum metal-free catalysts, such as Ni and Ni alloy catalysts. In addition, much cheaper stainless steel bipolar plates can be used in the gas diffusion layers (GDL) for AEM-WE, instead of the expensive Pt-coated Ti bipolar plates currently used in PEM-WE. However, the largest impediments to the development of AEM systems are membrane hydroxyl ion conductivity and stability, as well as lack of understanding of how to integrate catalysts into AEM systems. Research on AEM-WE in the literature has been focused on developing electrocatalysts, AEMs, and understanding the operational mechanisms with the general objective of obtaining a high efficiency, low cost and stable AEM-WE technology.

Fuel cells, as a next generation clean energy resource, convert the energy of chemical reactions such as an oxidation/reduction redox reaction of hydrogen and oxygen into electric energy. The three main types of fuel cells are alkaline electrolyte fuel cells, polymer electrolyte membrane fuel cells, and solid oxide fuel cells. Polymer electrolyte membrane fuel cells may include proton exchange membrane fuel cells (PEM-FC), anion exchange membrane fuel cells (AEM-FC), and direct methanol fuel cells. PEM-FC uses a PEM to conduct protons from the anode to the cathode, and it also separates the H₂ and O₂ gases to prevent gas crossover. AEM-FC uses an AEM to conduct OH⁻ from the cathode to the anode, and it also separates the H₂ and O₂ gases to prevent gas crossover.

The anode in an electrochemical cell is the electrode at which the predominant reaction is oxidation (e.g., the water oxidation/oxygen evolution reaction electrode for a water electrolyzer, or the hydrogen oxidation electrode for a fuel cell). The cathode in an electrochemical cell is the electrode at which the predominant reaction is reduction (e.g., the proton reduction/hydrogen evolution reaction electrode for a water electrolyzer, or the oxygen reduction electrode for a fuel cell). The membrane is one of the key materials that make up an electrolysis cell or a fuel cell and is an important driver for safety and performance. Some important properties for membranes for fuel cells and membrane electrolysis include high conductivity, high ionic permeability, high ionic exchange capacity (for ion-exchange membrane), high ionic/H₂ and O₂ selectivity (low H₂ and O₂ permeability/crossover), low price, low area resistance to minimize efficiency loss resulting from ohmic polarization, high resistance to oxidizing and reducing conditions, being chemically inert at a wide pH range, high thermal stability together with high proton conductivity, and high mechanical strength (thickness, low swelling).

Significant advances are needed in cost-effective, high performance, stable catalysts, membrane materials, as well as other cell stack components for PEM water electrolysis and PEM-FCs and AEM water electrolysis and AEM-FCs with a wide range of applications in renewable energy systems.

### BRIEF DESCRIPTION OF THE DRAWINGS

The patent or application file contains at least one photograph executed in color. Copies of this patent or patent application publication with color photograph(s) will be provided by the Office upon request and payment of the necessary fee.

FIG. 1 is an illustration of one embodiment of a PEM-WE cell.

FIG. 2 is an illustration of one embodiment of an AEM-WE cell.

FIGS. 3A and 3B are scanning transmission electron microscope (STEM) images of substantially continuous IrOx/TiO₂ core-shell catalysts.

FIG. 4 is of a STEM image of a non-continuous IrOₓ/TiO₂ catalyst.

FIG. 5 is a graph of comparing the polarization curves of single water electrolysis cells.

FIG. 6 is a graph comparing the high-frequency resistance (HFR) over current density of single water electrolysis cells.

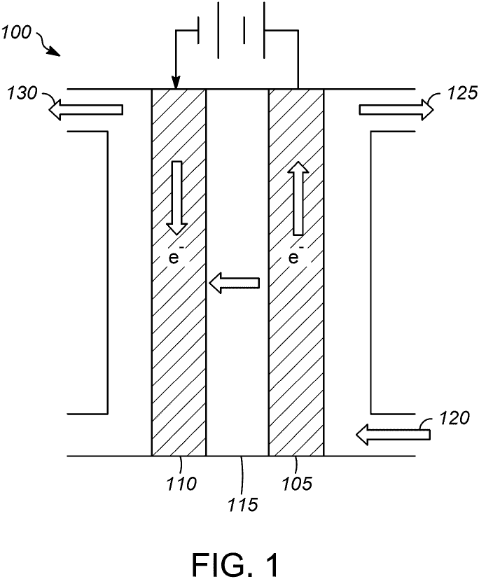

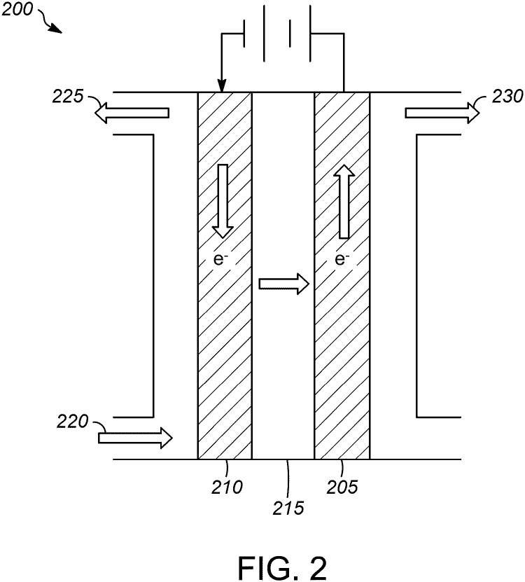

### DETAILED DESCRIPTION

Novel methods of preparing catalysts for oxygen evolution reaction (OER) that can be used in a PEM or AEM water electrolyzer (WE) have been developed. Using these methods, highly active and stable catalysts with reduced precious metal loading can be produced. The new catalysts show improved OER performance compared to a commercial IrO₂ catalyst.

One aspect is a method of making a water electrolysis catalyst. In one embodiment, the method comprises depositing a substantially continuous thin shell layer of a platinum group metal (PGM)-based precursor on a nano-sized inorganic oxide core to form a coated inorganic oxide core; heating the coated inorganic oxide core in the presence of a template to convert the substantially continuous thin shell layer of the PGM-based precursor to a substantially continuous thin shell layer of PGM oxide; and removing the template to form the water electrolysis catalyst comprising the nano-sized inorganic oxide core having the substantially continuous thin shell layer of the PGM oxide, wherein the water electrolysis catalyst comprises less than 30 wt% of the PGM oxide. The PGM oxide comprises a PGM oxide nanoparticle, a PGM oxide nanoparticle agglomerate, or combinations thereof. “Substantially continuous” means more than 90% of the surface of the nano-sized inorganic oxide core is covered by a thin shell layer of a PGM-based precursor or a thin shell layer of the PGM oxide and the distance between one PGM oxide nanoparticle and a closest neighbor PGM oxide nanoparticle within the shell layer is less than 5 nm. The substantially continuous thin shell layer has a thickness of less than 10 nm, or less than 7 nm, or in the range of 0.1 nm to 10 nm, or 1 nm to 7 nm. The nano-sized inorganic oxide core particles have a size in the range of 10 nm to 500 nm, or 10 nm to 200 nm, or 10 nm to 50 nm.

A substantially continuous thin layer of a platinum group metal-based precursor is deposited on the nano-sized non-conductive inorganic oxide support, such as TiO₂, WO₃, and the like forming a coated inorganic oxide core. The solid coated inorganic oxide obtained from the first step is thermally treated in the presence of a template to generate a conductive nano-sized material without particle aggregation.

The thermal treatment involves heating the coated inorganic oxide core at a temperature in the range of 250 to 600° C., or 300 to 550° C., or 350 to 450° C. for a time in the range of 0.5 h to 12 h, or 0.5 h to 6 h, or 1 h to 3 h. The thermal treatment converts the substantially continuous thin shell layer of PGM precursor into a substantially continuous thin shell layer of PGM oxide.

The template is removed by a washing process forming the water electrolysis catalyst which comprises a nano-sized inorganic oxide core having the substantially continuous thin shell layer of the PGM oxide. In some embodiments, the washing process involves the use of deionized water to wash away the template. In some embodiments, the washing process involves the use of deionized water followed by an organic solvent. Suitable organic solvents for the washing process include, but are not limited to, an alcohol such as methanol, ethanol, isopropanol, 1-propanol, acetone, an ether such as dimethyl ether, a hydrocarbon solvent such as n-heptane, n-hexane, or combinations thereof. The water electrolysis catalyst comprises less than 30 wt% of the PGM oxide. In some embodiments, the water electrolysis catalyst comprises less than 25 wt% of the PGM oxide, or less than 20%.

In some embodiments, the coated inorganic oxide core is dried at a temperature in a range of about 15 to about 100° C., or about 20 to about 60° C., or about 20 to about 40° C. in a vacuum oven, and the dried coated inorganic oxide core is mixed with the template before heating the coated inorganic oxide core.

The template can be an inorganic template or an organic template. Suitable inorganic templates include, but are not limited to, NaNO₃, LiNO₃, KNO₃, Mg(NO₃)₂, Ca(NO₃)₂, NaCl, KCl, or combinations thereof. Suitable organic templates include, but are not limited to, citric acid, malic acid, ascorbic acid, glycerol, ethylene glycol, triethylene glycol, polyethylene oxide, polyethlyene glycol, polyvinyl alcohol, poly(acrylic acid), poly(malic acid), poly(lactic acid), or combinations thereof.

Suitable PGMs include, but are not limited to, platinum, iridium, ruthenium, gold, rhodium, palladium, osmium, or combinations thereof.

Suitable nano-sized inorganic oxide cores include, but are not limited to, titanium dioxide, tungsten trioxide, molybdenum trioxide, alumina, tungsten doped titanium dioxide, niobium doped titanium dioxide, or combinations thereof.

Using this method, supported metal oxide catalysts have been prepared which are highly conductive, active and stable for OER in PEM-WE cell testing. The synthesis of prior art water electrolysis catalysts do not use a template during the thermal treatment. However, the use of a template, whether inorganic or organic, is highly beneficial to generate small catalyst particles, which allows the preparation of high quality catalyst coated membranes (CCM) for water electrolysis applications.

The use of a support in the OER catalyst provides several benefits. The precious metal oxide loading on the CCM to achieve targeted water electrolysis performance is reduced because of the much smaller and active catalytic sites. In addition, the performance is stable because of the strong support/active site interaction. For example, catalysts have been produced using this method which exhibited superior performance as compared to the commercial IrO₂ catalysts with only half of the IrO₂ loading.

Another aspect is a water electrolysis catalyst. In one embodiment, water electrolysis catalyst comprises: a nano-sized inorganic oxide core having a substantially continuous thin shell layer of a platinum group metal (PGM) oxide, wherein the water electrolysis catalyst comprises less than 30 wt% of the PGM oxide.

In some embodiments, the water electrolysis catalyst comprises less than 25 wt% of the PGM oxide, or less than 20 wt% of the PGM oxide.

In some embodiments, the PGM comprises platinum, iridium, ruthenium, gold, rhodium, palladium, osmium, or combinations thereof.

In some embodiments, the PGM is iridium or a combination of iridium and ruthenium.

In some embodiments, the nano-sized inorganic oxide core comprises titanium dioxide, tungsten trioxide, molybdenum trioxide, alumina, tungsten doped titanium dioxide, niobium doped titanium dioxide, or combinations thereof.

In some embodiments, the nano-sized inorganic oxide core comprises titanium dioxide, tungsten doped titanium dioxide, niobium doped titanium dioxide, or combinations thereof.

In some embodiments, a distance between one PGM oxide nanoparticle and a closest neighbor PGM oxide nanoparticle within the shell layer is less than 5 nm and the thickness of the thin shell layer is less than 10 nm.

In some embodiments, the thickness of the thin shell layer is less than 7 nm.

### EXAMPLES

### Example 1. Synthesis of a Continuous IrOx/TiO₂ Core-Shell Catalyst

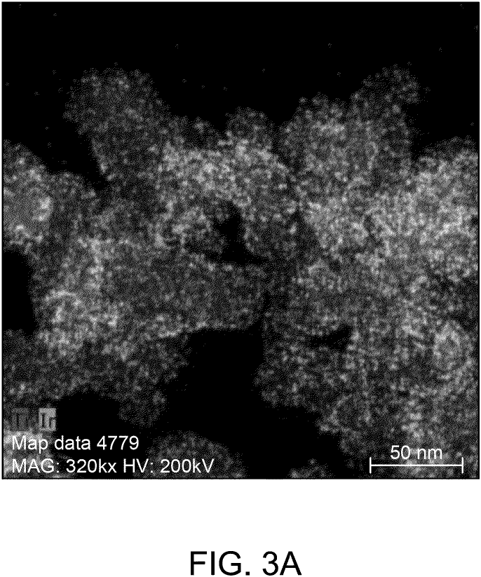

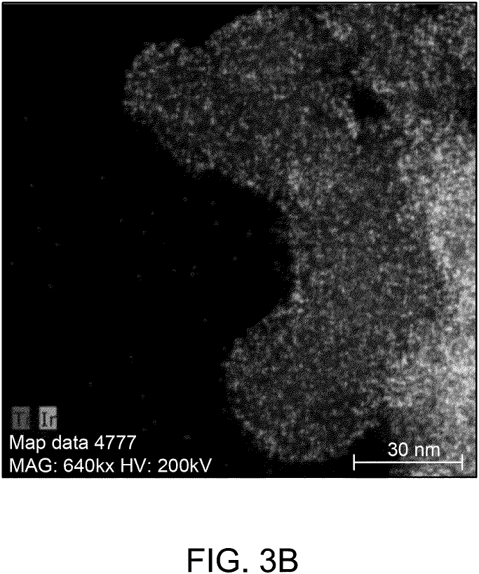

A sample of 200 mg of IrCl₃•xH₂O was mixed with 10 mL of water and sonicated at room temperature for 30 minutes to ensure full dissolution. An amount of 253 mg of TiO₂ (56 m²/g) was added to the Ir solution, and the mixture was sonicated for another 30 minutes. The mixture was heated to 70° C. in a water bath, and the pH was adjusted to 11.00 using an appropriate amount of 0.66 M NaOH aqueous solution. The system was kept at 70° C. for another 16 hours. A blue solid was recovered after centrifugation, which was washed with water three times and with methanol one time. The recovered solid was dried and mixed with 4.95 g of NaNO₃ and ground well. It was heated at 365° C. for 1 hour before the temperature was brought down to 50° C. The recovered solid was then washed with copious amounts of deionized water and dried to form a substantially continuous IrOₓ/TiO₂ core-shell catalyst. The Ir loading of the substantially continuous IrOₓ/TiO₂ core-shell catalyst was determined to be 22.0 wt% via Inductively coupled plasma optical emission spectrometry (ICP-OES) measurement. The substantially continuous IrOₓ thin shell layer with < 7 nm mean thickness on the TiO₂ core can be seen from the scanning transmission electron microscope (STEM) images in FIGS. 3.

### Comparative Example 1. Synthesis of a Non-Continuous IrOₓ/TiO₂ catalyst

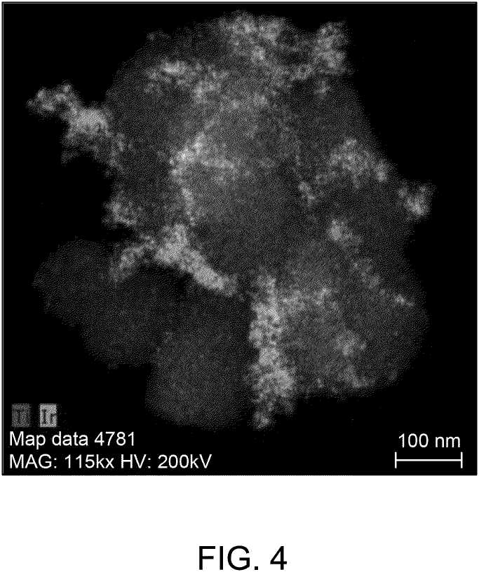

A sample of 200 mg IrCl₃•xH₂O was mixed with 10 mL of isopropyl alcohol, which was then mixed with 253 mg of TiO₂. After sonication at room temperature for 30 minutes, 4.95 g of NaNO₃ was added to the mixture. After drying the mixture at 70° C. to remove all the liquid, the solid was ground well at room temperature. The solid was then calcined at 365° C. for 1 hour. The solid was washed with copious amounts of water and dried. The coating was determined to be non-continuous IrOₓ on the TiO₂ particles. The non-continuous aggregated IrO₂ on TiO₂ can be seen from the STEM image in FIG. 4.

### Example 2. Water Electrolysis Performance of Continuous IrOx/TiO₂ Core-Shell Catalyst and Non-Continuous IrOₓ/TiO₂ Catalyst

The water electrolysis performance of the continuous IrOx/TiO₂ core-shell catalyst and the non-continuous IrOₓ/TiO₂ catalyst was evaluated using a single water electrolysis cell comprising a catalyst coated membrane (CCM) using the continuous IrOx/TiO₂ core-shell catalyst (abbreviated as continuous IrOx/TiO₂ core-shell catalyst CCM) and a catalyst coated membrane using the non-continuous IrOₓ/TiO₂ catalyst (abbreviated as IrOx/TiO₂ catalyst CCM), respectively, at 80° C., atmospheric pressure.

The continuous IrOx/TiO₂ core-shell catalyst CCM comprising the continuous IrOx/TiO₂ core-shell catalyst was prepared by a catalyst coated on membrane method using the continuous IrOx/TiO₂ core-shell catalyst as an oxygen evolution reaction (OER) catalyst for the anode. The continuous IrOx/TiO₂ core-shell catalyst ink for spray coating was prepared by mixing the catalyst and Nafion® (tetrafluoroethylene based perfluorinated sulfonic acid ionomer ) ionomer (5 wt% in alcohol) in deionized (DI) water and alcohol. The mixture was finely dispersed using an ultrasonication bath. The Nafion® ionomer content in the anode was controlled to about 10 wt% in the total content of the catalyst and Nafion® ionomer. The catalyst ink was spray coated onto one side of a Fumasep® FS-990-PK (Polyether ether ketone-reinforced perfluorinated cation exchange membrane) membrane. The continuous IrOx/TiO₂ core-shell catalyst loading was about 0.3 mg/cm². The continuous IrOx/TiO₂ core-shell catalyst CCM was sandwiched between a Pt-coated carbon paper (as a hydrogen evolution reaction (HER) catalyst-coated cathode porous transport layer) and a Pt-coated Ti-felt (as an anode porous transport layer) to form a continuous IrOx/TiO₂ core-shell catalyst-based membrane electrode assembly. The testing cell was installed using the continuous IrOx/TiO₂ core-shell catalyst-based membrane electrode assembly.

The non-continuous IrOₓ/TiO₂ catalyst CCM comprising the non-continuous IrOₓ/TiO₂ catalyst was prepared by a catalyst coated on membrane method using the non-continuous IrOₓ/TiO₂ catalyst as an OER catalyst for the anode. The non-continuous IrOₓ/TiO₂ catalyst ink for spray coating was prepared by mixing the catalyst and Nafion® ionomer (5 wt% in alcohol) in DI water and alcohol. The mixture was finely dispersed using an ultrasonication bath. Nafion® ionomer content in the anode was controlled to about 10 wt% in the total content of the catalyst and Nafion® ionomer. The catalyst ink was spray coated onto one side of a Fumasep® FS-990-PK membrane. The non-continuous IrOₓ/TiO₂ catalyst loading was about 0.35 mg/cm². The non-continuous IrOₓ/TiO₂ catalyst-based CCM was sandwiched between a Pt-coated carbon paper (as a HER catalyst-coated cathode porous transport layer) and a Pt-coated Ti-felt (as an anode porous transport layer) to form a non-continuous IrOₓ/TiO₂ catalyst-based membrane electrode assembly. The testing cell was installed using the non-continuous IrOₓ/TiO₂ catalyst-based membrane electrode assembly.

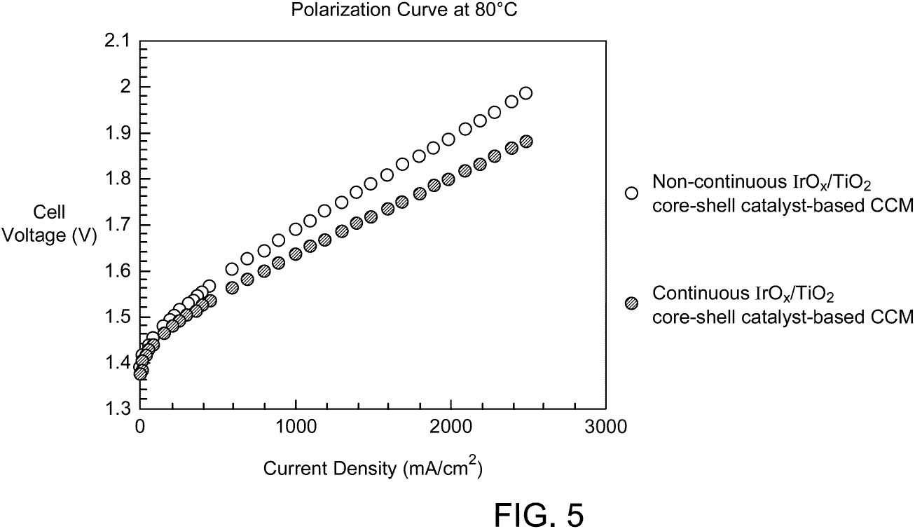

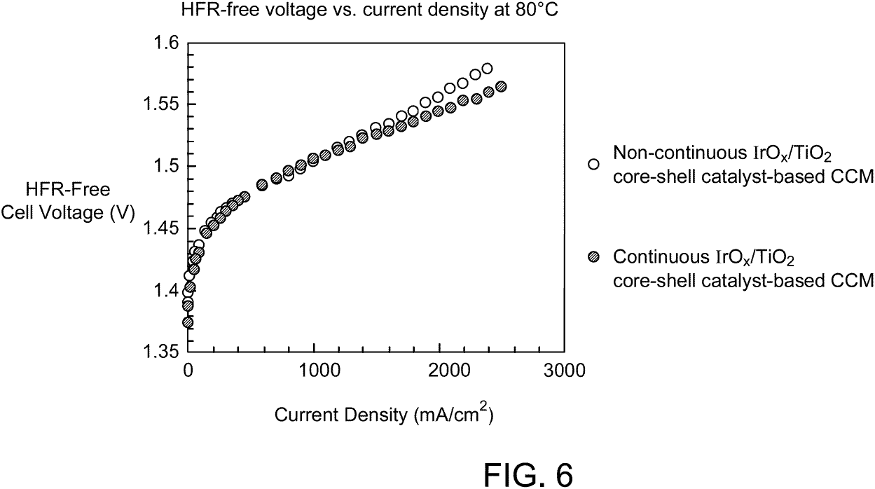

A proton exchange membrane (PEM) water electrolysis test station (Scribner 600 electrolyzer test system) was used to evaluate the water electrolysis performance of the continuous IrOₓ/TiO₂ core-shell catalyst CCM and the non-continuous IrOₓ/TiO₂ catalyst CCM in a single electrolyzer cell with an active membrane area of 5 cm². The test station included an integrated power supply, a potentiostat, an impedance analyzer for electrochemical impedance spectroscopy (EIS) and high-frequency resistance (HFR), and real-time sensors for product flow rate and cross-over monitoring. The testing was conducted at 80° C. and at atmospheric pressure. Ultrapure water was supplied to the anode of the cell with a flow rate of 100 mL/min. The cell was heated to 80° C. and held for 1 h at 200 mA/cm² and 1 h at 1 A/cm². These steps were counted together as one conditioning cycle. After the conditioning, the polarization curve was prepared (each datapoint end of 1 min hold) as shown in FIG. 5. FIG. 6 shows he HFR-free voltage over current density for the continuous IrOx/TiO₂ core-shell catalyst CCM and the non-continuous IrOₓ/TiO₂ catalyst CCM. It can be seen that from FIG. 5 that the continuous IrOx/TiO₂ core-shell catalyst CCM showed much lower cell voltage than the non-continuous IrOₓ/TiO₂ catalyst CCM at commercially viable 1.5 A/cm² or higher current density, indicating that the continuous IrOx/TiO₂ core-shell catalyst CCM has higher cell efficiency than the non-continuous IrOₓ/TiO₂ catalyst CCM. The results in FIG. 6 shows that the continuous IrOx/TiO₂ core-shell catalyst CCM has lower HFR-free voltage than the non-continuous IrOₓ/TiO₂ catalyst CCM at 1.5 A/cm² or higher current density, which contributes to the lower cell voltage for the continuous IrOx/TiO₂ core-shell catalyst CCM.

As used herein, the term about means within 10% of the value, or within 5%, or within 1%.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

### SPECIFIC EMBODIMENTS

While the following is described in conjunction with specific embodiments, it will be understood that this description is intended to illustrate and not limit the scope of the preceding description and the appended claims.

A first embodiment of the invention is a method of making a water electrolysis catalyst comprising depositing a substantially continuous thin shell layer of a platinum group metal (PGM)-based precursor on a nano-sized inorganic oxide core to form a coated inorganic oxide core; heating the coated inorganic oxide core in the presence of a template to convert the substantially continuous thin shell layer of the PGM-based precursor to a substantially continuous thin shell layer of PGM oxide; and removing the template to form the water electrolysis catalyst comprising the nano-sized inorganic oxide core having the substantially continuous thin shell layer of the PGM oxide, wherein the water electrolysis catalyst comprises less than 30 wt% of the PGM oxide. An embodiment of the invention is one, any or all of prior embodiments in this paragraph up through the first embodiment in this paragraph wherein the template comprises an inorganic template or an organic template. An embodiment of the invention is one, any or all of prior embodiments in this paragraph up through the first embodiment in this paragraph wherein the inorganic template comprises NaNO₃, LiNO₃, KNO₃, Mg(NO₃)₂, Ca(NO₃)₂, NaCl, KCl, or combinations thereof. An embodiment of the invention is one, any or all of prior embodiments in this paragraph up through the first embodiment in this paragraph wherein the organic template comprises citric acid, malic acid, ascorbic acid, glycerol, ethylene glycol, triethylene glycol, polyethylene oxide, polyethlyene glycol, polyvinyl alcohol, poly(acrylic acid), poly(malic acid), poly(lactic acid), or combinations thereof. An embodiment of the invention is one, any or all of prior embodiments in this paragraph up through the first embodiment in this paragraph further comprising drying the coated inorganic oxide core; mixing the dried coated inorganic oxide core with the template before heating the coated inorganic oxide core. An embodiment of the invention is one, any or all of prior embodiments in this paragraph up through the first embodiment in this paragraph wherein the PGM comprises platinum, iridium, ruthenium, gold, rhodium, palladium, osmium, or combinations thereof. An embodiment of the invention is one, any or all of prior embodiments in this paragraph up through the first embodiment in this paragraph wherein the nano-sized inorganic oxide core comprises titanium dioxide, tungsten trioxide, molybdenum trioxide, alumina, tungsten doped titanium dioxide, niobium doped titanium dioxide, or combinations thereof. An embodiment of the invention is one, any or all of prior embodiments in this paragraph up through the first embodiment in this paragraph wherein the water electrolysis catalyst comprises less than 25 wt% of the PGM oxide. An embodiment of the invention is one, any or all of prior embodiments in this paragraph up through the first embodiment in this paragraph wherein the water electrolysis catalyst comprises less than 20 wt% of the PGM oxide.

A second embodiment of the invention is a water electrolysis catalyst comprising a nano-sized inorganic oxide core having a substantially continuous thin shell layer of a platinum group metal (PGM) oxide, wherein the water electrolysis catalyst comprises less than 30 wt% of the PGM oxide. An embodiment of the invention is one, any or all of prior embodiments in this paragraph up through the second embodiment in this paragraph wherein the PGM comprises platinum, iridium, ruthenium, gold, rhodium, palladium, osmium, or combinations thereof. An embodiment of the invention is one, any or all of prior embodiments in this paragraph up through the second embodiment in this paragraph wherein the PGM is iridium or a combination of iridium and ruthenium. An embodiment of the invention is one, any or all of prior embodiments in this paragraph up through the second embodiment in this paragraph wherein the nano-sized inorganic oxide core comprises titanium dioxide, tungsten trioxide, molybdenum trioxide, alumina, tungsten doped titanium dioxide, niobium doped titanium dioxide, or combinations thereof. An embodiment of the invention is one, any or all of prior embodiments in this paragraph up through the second embodiment in this paragraph wherein the nano-sized inorganic oxide core comprises titanium dioxide, tungsten doped titanium dioxide, niobium doped titanium dioxide, or combinations thereof. An embodiment of the invention is one, any or all of prior embodiments in this paragraph up through the second embodiment in this paragraph wherein the water electrolysis catalyst comprises less than 25 wt% of the PGM oxide. An embodiment of the invention is one, any or all of prior embodiments in this paragraph up through the second embodiment in this paragraph wherein the water electrolysis catalyst comprises less than 20 wt% of the PGM oxide. An embodiment of the invention is one, any or all of prior embodiments in this paragraph up through the second embodiment in this paragraph wherein a distance between one PGM oxide nanoparticle and a closest neighbor PGM oxide nanoparticle within the shell layer is less than 5 nm and a thickness of the thin shell layer is less than 10 nm. An embodiment of the invention is one, any or all of prior embodiments in this paragraph up through the second embodiment in this paragraph wherein a thickness of the thin shell layer is less than 7 nm.

Without further elaboration, it is believed that using the preceding description that one skilled in the art can utilize the present invention to its fullest extent and easily ascertain the essential characteristics of this invention, without departing from the spirit and scope thereof, to make various changes and modifications of the invention and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

What is claimed is:

1. A method of making a water electrolysis catalyst comprising:
depositing a substantially continuous thin shell layer of a platinum group metal (PGM)-based precursor on a nano-sized inorganic oxide core to form a coated inorganic oxide core;
heating the coated inorganic oxide core in the presence of a template to convert the substantially continuous thin shell layer of the PGM-based precursor to a substantially continuous thin shell layer of PGM oxide; and
removing the template to form the water electrolysis catalyst comprising the nano-sized inorganic oxide core having the substantially continuous thin shell layer of the PGM oxide, wherein the water electrolysis catalyst comprises less than 30 wt% of the PGM oxide.

2. The method of claim 1 wherein the template comprises an inorganic template or an organic template.

3. The method of claim 2 wherein the inorganic template comprises NaNO₃, LiNO₃, KNO₃, Mg(NO₃)₂, Ca(NO₃)₂, NaCl, KCl, or combinations thereof.

4. The method of claim 2 wherein the organic template comprises citric acid, malic acid, ascorbic acid, glycerol, ethylene glycol, triethylene glycol, polyethylene oxide, polyethlyene glycol, polyvinyl alcohol, poly(acrylic acid), poly(malic acid), poly(lactic acid), or combinations thereof.

5. The method of claim 1 further comprising:
drying the coated inorganic oxide core; and
mixing the dried coated inorganic oxide core with the template before heating the coated inorganic oxide core.

6. The method of claim 1 wherein the PGM comprises platinum, iridium, ruthenium, gold, rhodium, palladium, osmium, or combinations thereof.

7. The method of claim 1 wherein the nano-sized inorganic oxide core comprises titanium dioxide, tungsten trioxide, molybdenum trioxide, alumina, tungsten doped titanium dioxide, niobium doped titanium dioxide, or combinations thereof.

8. The method of claim 1 wherein the water electrolysis catalyst comprises less than 25 wt% of the PGM oxide.

9. The method of claim 1 wherein the water electrolysis catalyst comprises less than 20 wt% of the PGM oxide.

10. A water electrolysis catalyst comprising:
a nano-sized inorganic oxide core having a substantially continuous thin shell layer of a platinum group metal (PGM) oxide, wherein the water electrolysis catalyst comprises less than 30 wt% of the PGM oxide.

11. The water electrolysis catalyst of claim 10 wherein the PGM comprises platinum, iridium, ruthenium, gold, rhodium, palladium, osmium, or combinations thereof.

12. The water electrolysis catalyst of claim 10 wherein the PGM is iridium or a combination of iridium and ruthenium.

13. The water electrolysis catalyst of claim 10 wherein the nano-sized inorganic oxide core comprises titanium dioxide, tungsten trioxide, molybdenum trioxide, alumina, tungsten doped titanium dioxide, niobium doped titanium dioxide, or combinations thereof.

14. The water electrolysis catalyst of claim 10 wherein the nano-sized inorganic oxide core comprises titanium dioxide, tungsten doped titanium dioxide, niobium doped titanium dioxide, or combinations thereof.

15. The water electrolysis catalyst of claim 10 wherein the water electrolysis catalyst comprises less than 25 wt% of the PGM oxide.

16. The water electrolysis catalyst of claim 10 wherein the water electrolysis catalyst comprises less than 20 wt% of the PGM oxide.

17. The water electrolysis catalyst of claim 10 wherein a distance between one PGM oxide nanoparticle and a closest neighbor PGM oxide nanoparticle within the shell layer is less than 5 nm and a thickness of the thin shell layer is less than 10 nm.

18. The water electrolysis catalyst of claim 10 wherein a thickness of the thin shell layer is less than 7 nm.
